(19) United States
(12) Patent Application Publication
(10) Pub. No.: US 2008/0052215 A1
(43) Pub. Date: Feb. 28, 2008

(54) Online omnibus trading system

(76) Inventor: Geoffrey M. Tudisco, Bridgehampton, NY (US)

Correspondence Address: JAMES D. FORNARI, ESQ.;C/O GERSTEN SAVAGE LLP, 600 LEXINGTON AVENUE, NEW YORK, NY, 10022, US

(21) Appl. No.: 11/443,948

(22) Filed: May 31, 2006

(51) Int. Cl. G06Q 40/00

(52) U.S. Cl. 705/37

(57) ABSTRACT

A trading system comprised of a multiplicity of entities each of which trades securities, among other instruments, presents itself to prime brokers and clearing entities as single account for all purposes, including trading, clearing and reconciliation, thereby creating an omnibus online system to provide the benefits of such prime broker trading and clearing to each of the multiplicity of entities comprising the participants in the system.

### FIELD OF THE INVENTION

The present invention relates to a computer system for permitting online omnibus trading for securities in general and in particular a computer system wherein funds that are managed by different managers trade through an omnibus system that provides operational services and execution to the funds.

### BACKGROUND OF THE INVENTION

Hedge fund have been growing in number during the past several years at an unprecedented rate. Approximately $17 billion dollars have flowed into hedge funds during the quarter ending September 2004, an amount almost double that during the prior quarter. Currently it is estimated that there is nearly $900 billion under management and that hedge funds will surpass the $1 trillion mark during the next 18 months. Projections have forecast that global hedge fund assests will increase to nearly $2 trillion by 2010, while other estimates predict that hedge fund assets will grow to nearly $6 trillion by the end of the decade.

Although hedge funds have been growing in number and assets under management, there exists a marked disparity in the size of hedge funds and the concomitant services and execution available to them. Much of the expected growth is predicted to come from the institutional investment community which will most likely to increase its current contribution by approximately 500%, from $60 billion to $300 billion, over the next several years. Institutional funds will have available to them the services and financial resources, as well as infrastructure, to permit them to attract capital and to make money, while complying with ever increasing and changing regulatory requirements. The jumbo hedge funds with assets in the vicinity of $500 million will continue to be a viable business and, so long as they perform at or about the level of the major averages, will have funds coming in to them. With the traditional 1-2% upfront fees of a large asset base coupled with a 20% payout from the profit, there are sufficient funds available to permit such jumbo funds to absorb the cost of audits, legal fees, regulatory requirements and administrative expenses that are inherent in the compliance now being required.

In contradistinction, the small and median size hedge funds are faced with almost insurmountable inequities, fragmentation and inefficiencies within the investment service community. As of December, 2003, the median hedge fund was between $22 million and $26.5 million, while the mean was approximately $100 million. Studies indicate that more than half of the hedge funds are smaller than $25 million and approximately 80% are smaller than $100 million.

Today, small and start-up hedge fund managers employ a patchwork of services. Trade execution is often though online brokerages such as Brown/Co. and TradeStation that do not give the manager the preferential commission structure afforded larger funds. Similarly, fund accounting is often accomplished through the use of Microsoft Excel, which does not provide appropriate mark-to-market and other accounting requirements for fund compliance. Furthermore, many of the small funds use inferior legal documentation which is likely to be out of compliance with applicable regulations and the performance of these funds is often un-audited, all of which contributes to their inability to raise significant capital. In short, for smaller funds the time and expense of complying with the increased expenses of auditing, legal, compliance, etc., so diminishes the effectiveness of the manager as to make the funds virtually incapable of providing the yields necessary to sustain them. When a higher percentage of the management fees go to compliance as opposed to paying the manager to find good investments and a higher percentage of the manager's time is spent trying to make incentive fees to offset the rising fixed costs, the entire endeavor become unprofitable.

Studies indicate that the primary reason for a hedge fund manager's decision to liquidate a fund is the inability to raise sufficient capital to sustain the fund's operation. Although performance attracts assets, attracting enough assets to make a fund a sustainable and profitable business is often a function of being able to demonstrate that the performance is real . . . this requires audits and compliance. Many small and start up funds turn to high cost outside vendors to provide both the marketing and verification to attract funds. Because the funds are small, they have little leverage with the vendors and often find that the cost is too much of a financial burden in both the short and long term.

Another problem is that prime brokers through which hedge funds must place trades for execution do not provide services to the small funds. They do not reconcile accounts, provide attractive leverage or give favorable commission rates, among other things. This results in a massive competitive disadvantage to smaller funds while yielding outsized commissions to the prime brokers, who have no incentive to assist the smaller funds in reducing their costs.

Although there have been some attempts to obtain better commission structures by employing “hedge fund hotels” where a number of funds consolidate their trades though a single prime broker, these trades are still on a fully disclosed basis and require at least 1000 trades in order to make them modestly attractive for a prime broker. Such consolidation, however, does not reduce the potential liability and often does not result in cost reductions because of the trade requirements. Moreover, there is still generally no reconciliation, compliance or auditing function provided.

### SUMMARY OF THE INVENTION

The invention permits small hedge funds to trade on a non-disclosed basis as though each was a jumbo hedge fund and obtain the advantages provided to such jumbo funds, receive reconciled positions, obtain prime broker execution and benefits, compliance and mark-to-market reports, position and cash balance data and reports of breaks, settlements, matched and unmatched trades for each small hedge fund, without aggregating the trades themselves. In addition, the invention permits the prime broker to reduce its reporting requirements and thereby significantly reduce the commissions charged.

### BRIEF DESCRIPTION OF THE DRAWINGS

FIG. 1 is a block diagram in schematic form of a an omnibus trading system to permit multiple client trading via the system, in accordance with an embodiment of the invention

FIG. 2 is a block diagram showing the major components of an omnibus trading system, in accordance with an embodiment of the invention.

FIG. 3 is a flowchart diagrammatically showing an overview of the system architecture of an omnibus trading system in accordance with an embodiment of the invention.

FIG. 4 is a block diagram of an illustrative trade capture overview.

FIG. 5 is a flowchart of a representative trade capture for a transaction with the flow architecture of the trade capture by vendor in an omnibus trading system in accordance with an embodiment of the invention.

FIG. 6 is a block diagram illustrative of the activities undertaken by the omnibus account holder in an omnibus trading system in accordance with an embodiment of the invention.

FIG. 7 is a flowchart of the repository verification for securities that are traded in an omnibus trading system in accordance with an embodiment of the invention.

### DESCRIPTION OF THE SPECIFIC EMBODIMENTS

In the figures, like elements are labeled with like numbers wherever possible and different instances or embodiments of like elements are labeled with like numbers, but will contain a differentiating number or letter if appropriate. For purposes of illustration only, the following definitions will be employed. It is understood that these are not meant to be inclusive.

A hedge fund is a an entity that invests or trades in stocks, securities or other financial instruments, or in commodities or other contracts and has the ability to go either long or short those instruments, hedge its transactions and otherwise engage in all forms of legitimate trading activity, usually on behalf of investors or limited partners (“LPs”) who have placed their funds with the hedge funds for financial management purposes.

A hedge fund manager is a person or entity that is responsible for the trades by the hedge fund as well as the regulatory and infrastructure requirements imposed by agencies, institutions and investors on the hedge fund.

An order is an instruction from a hedge fund to undertake some activity such as buy, sell, other otherwise alter their current account position.

A trade is a transaction that would be executed on behalf of a hedge fund in response to an order.

An exchange is an entity, place or system to permit the executions of trades of securities or other instruments or an organized market or center for such trading.

A prime broker is an entity through which trades are placed for execution. A prime broker will have an account for each entity or person for whom it is serving as prime broker.

An omnibus account is a single account with a prime broker (or other entity authorized and capable of executing trades) in which the prime broker sees a single client and is only responsible for proving required trade data to that single client.

A omnibus trading system is a computer system, or collection of computer systems operating together or interrelated to or associated with one another, to act as a single client to the prime broker while providing to each of the clients (generally hedge fund participants) the required trade information particular to each fund for each trade, including profit/loss positions, cash balance, mark-to-market data and statements, reconciliation and required reports, among other things.

A fully disclosed relationship with a clearing firm differs substantially from an omnibus relationship. The most salient difference is that in a fully disclosed model, the clearing broker maintains individual accounts for each end client of the introducing broker/dealer. In an omnibus clearing arrangement, the clearing broker maintains a single consolidated account for a carrying broker/dealer and only the carrying broker/dealer knows the end client. The prime broker sees the omnibus account as a single client. Therefore, the omnibus model offers significant economies of scale because the clearing firm is only servicing a single account. The task of reallocating the omnibus account to the various individual hedge fund managers is performed by the carrying broker/dealer through the computer system of this invention. The system can, among other things, provide reports to each hedge fund manager, provide web based profit/loss position statements, supply compliance mark to market data and statements, and reconcile the required reports and trades.

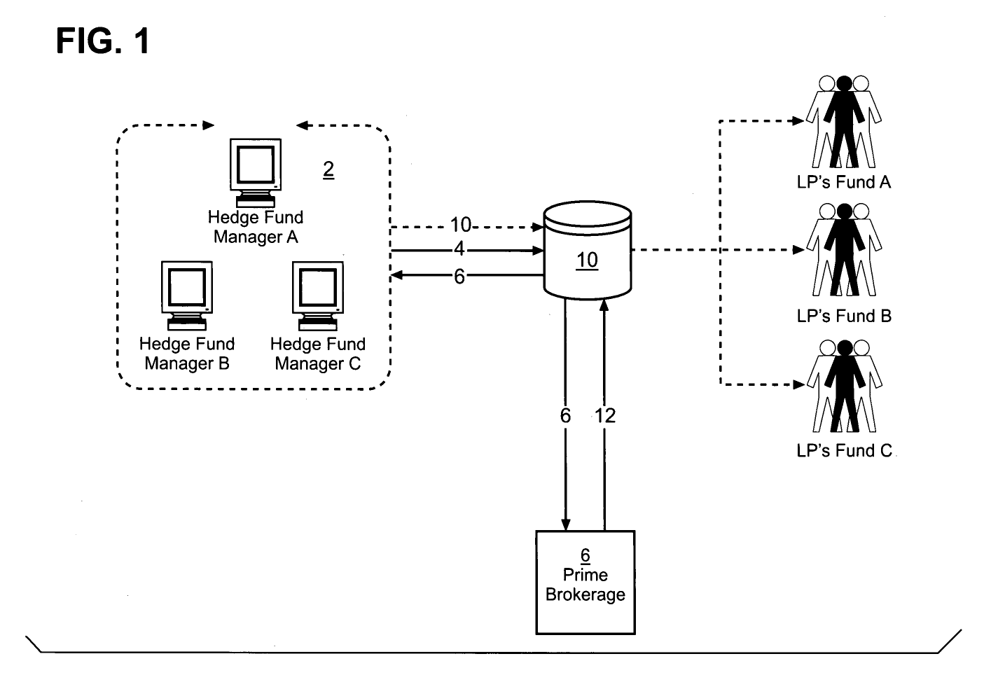

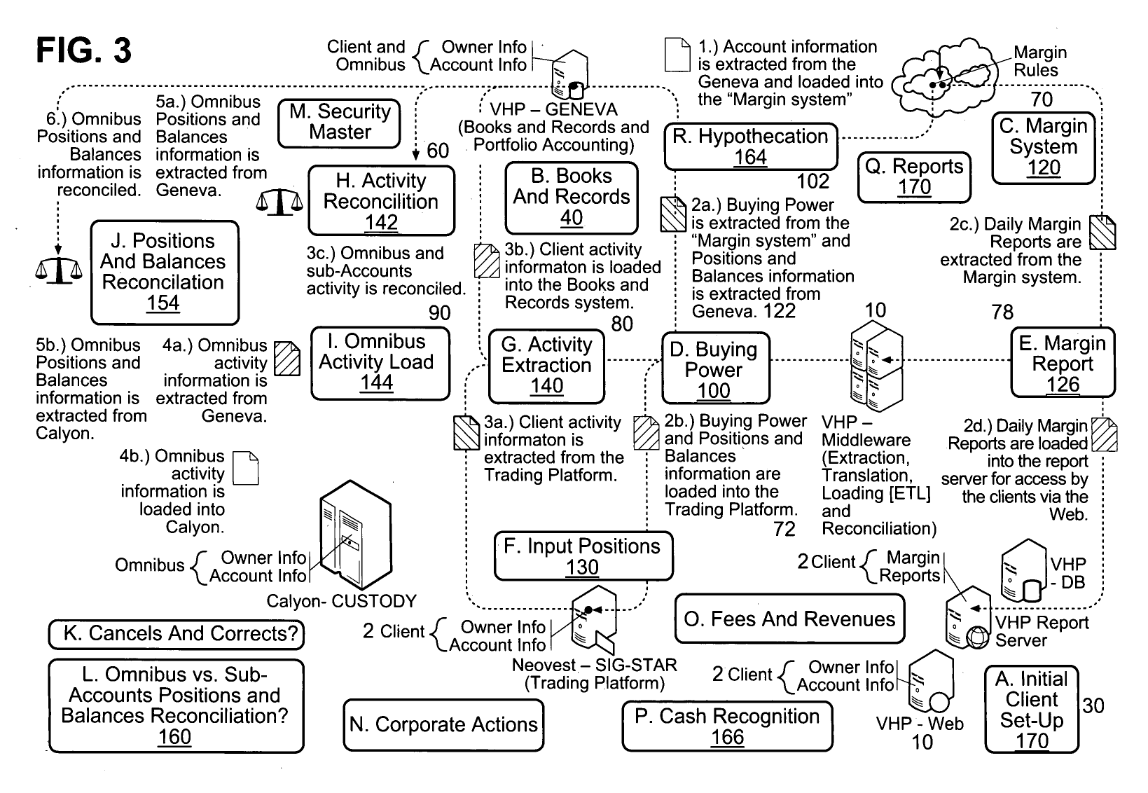

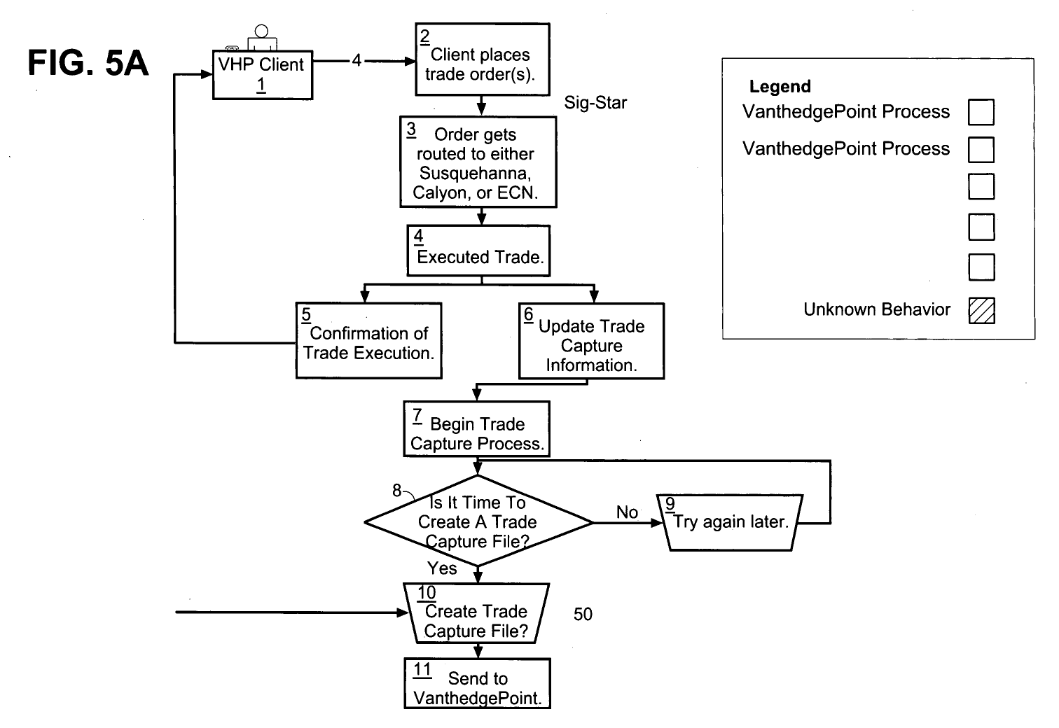

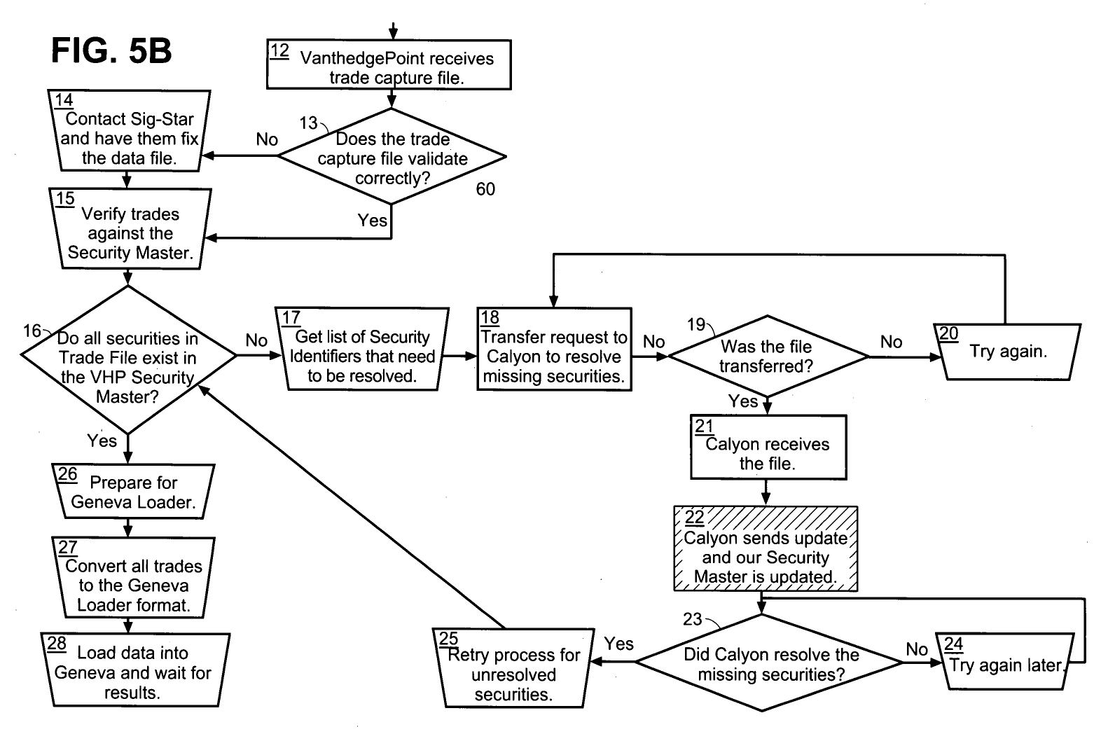

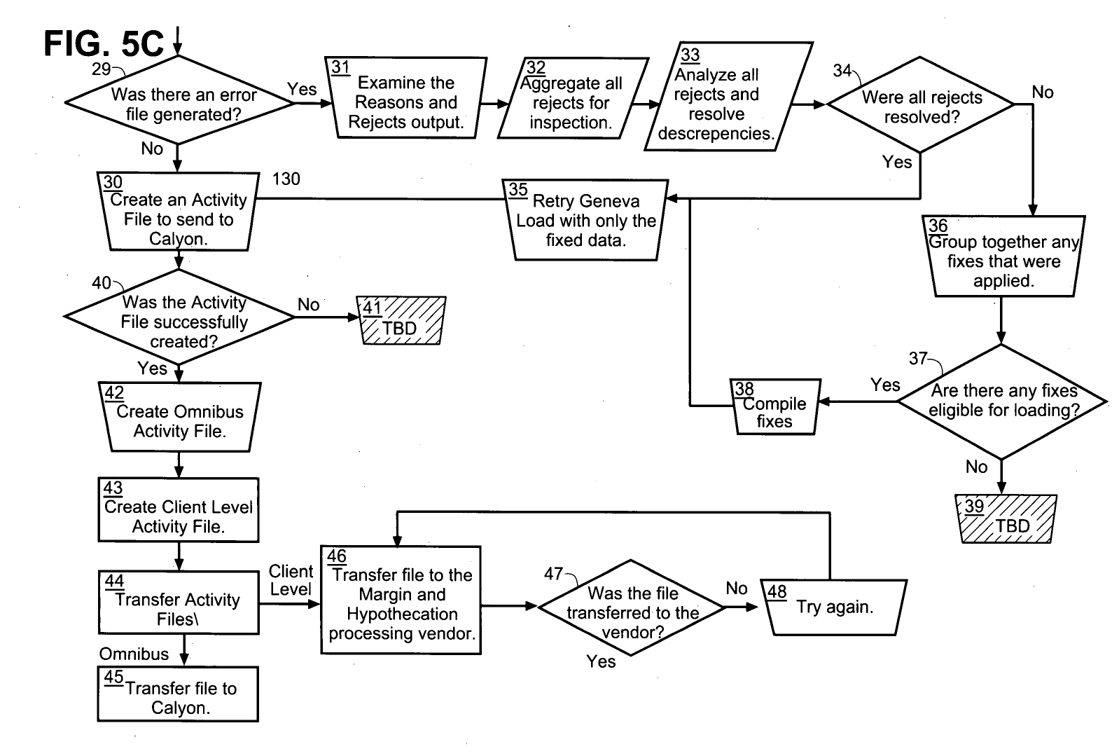

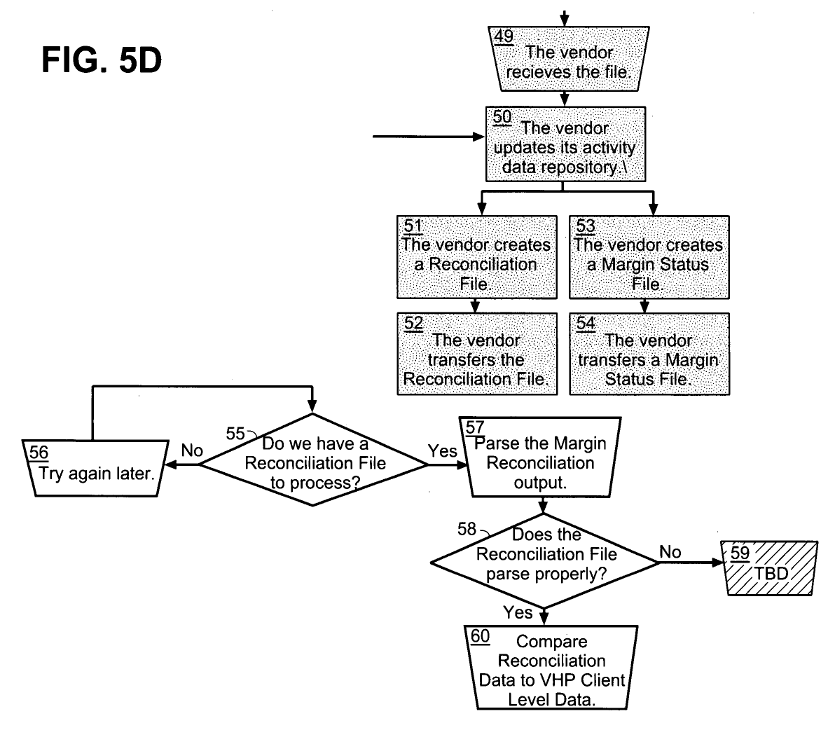

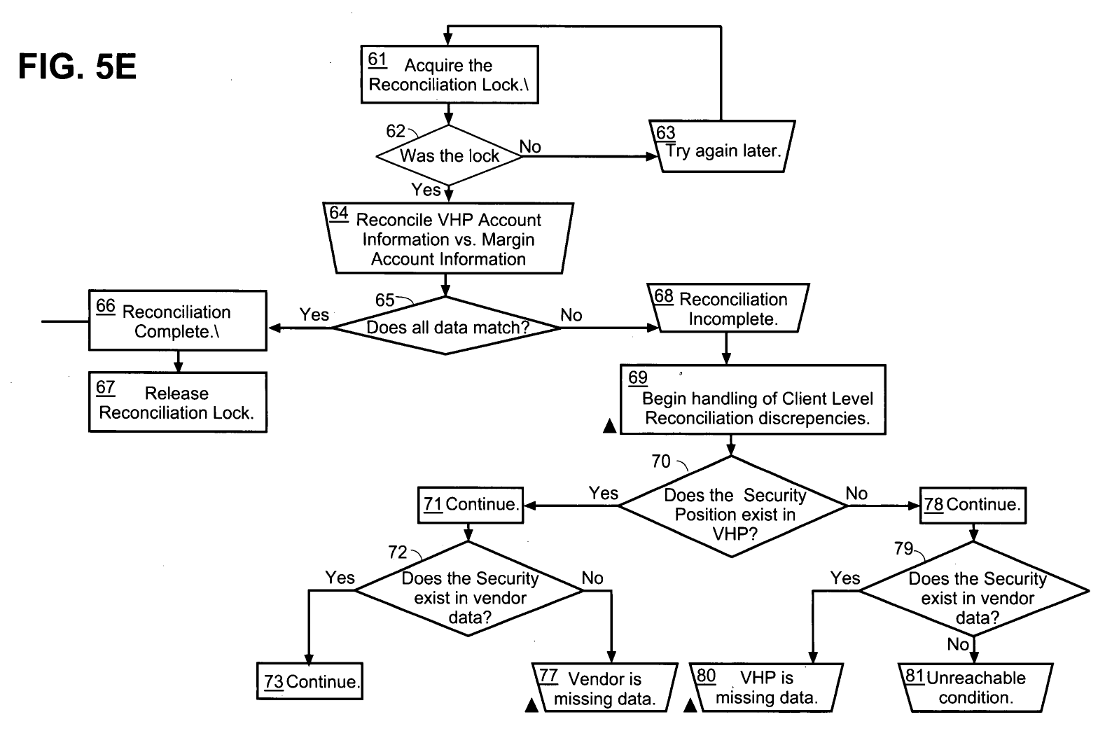

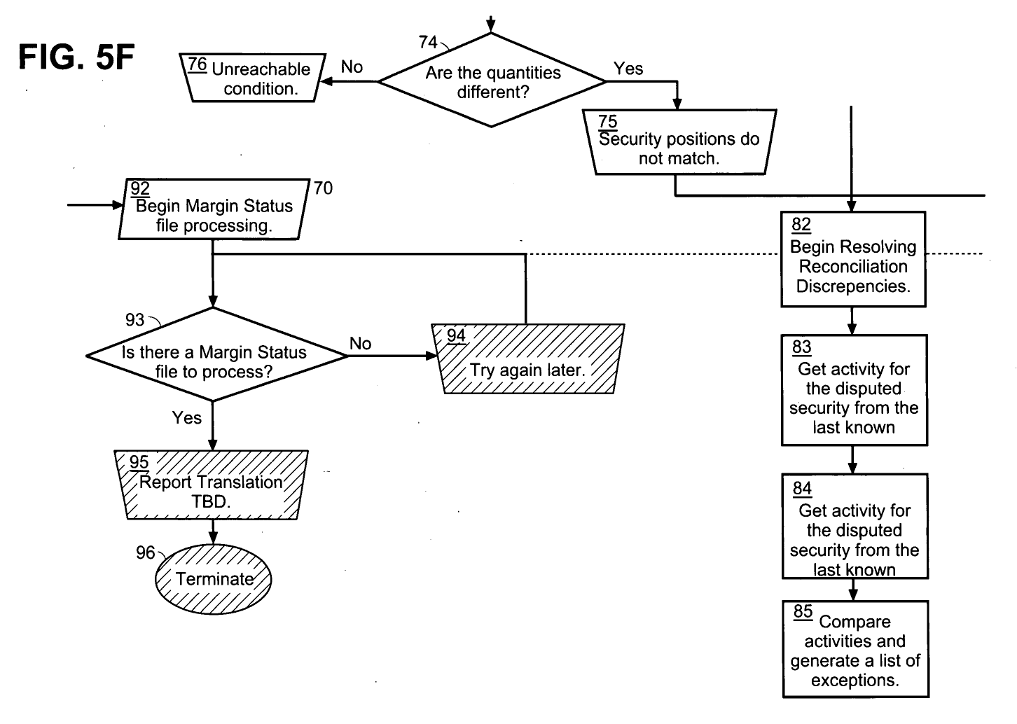

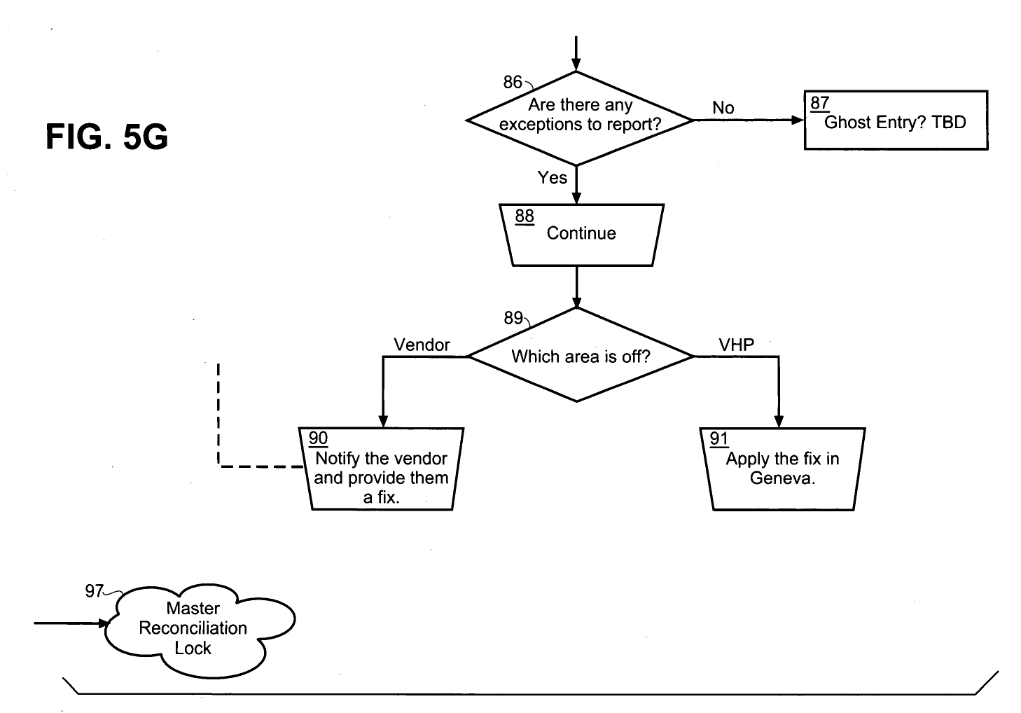

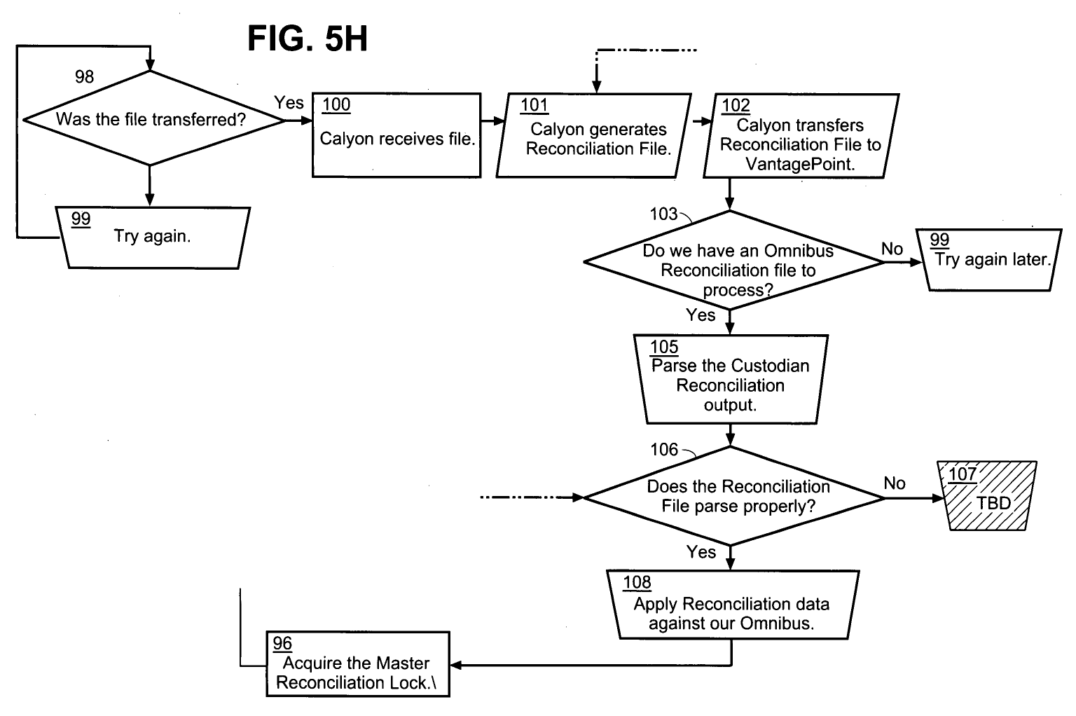

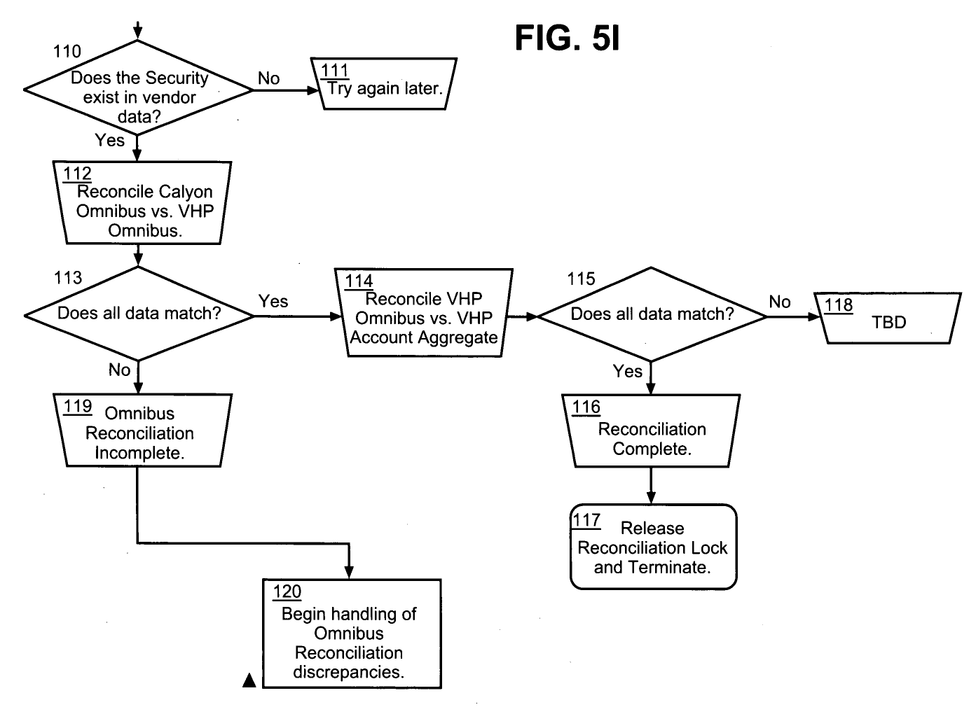

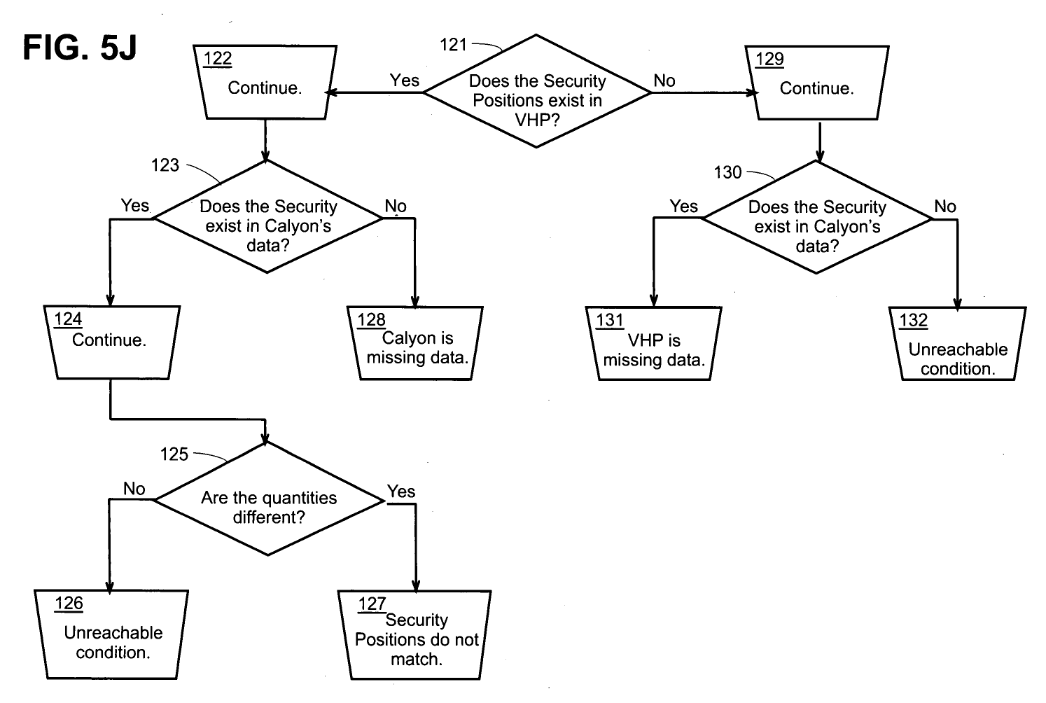

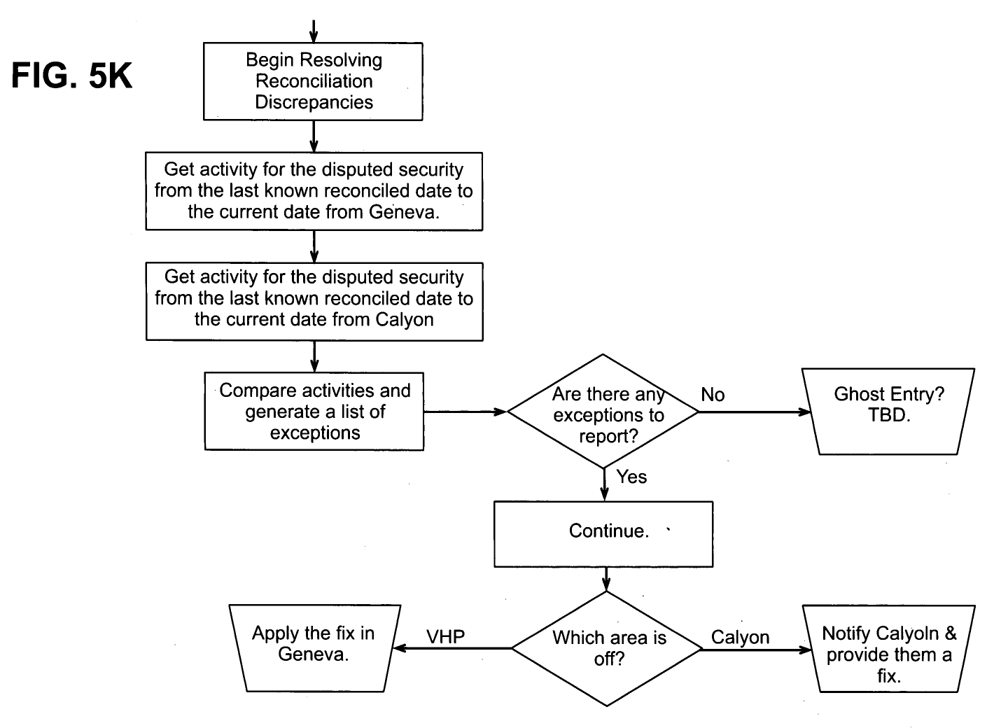

In the basic omnibus trading system described in FIG. 1, the various components of the system and their general activities are diagrammatically depicted. When viewed in conjunction with FIG. 3 and FIG. 5, for illustrative purposes, a client 2 places a trade 4 through the system, that trade 4 is recognized and placed by the omnibus trading system 10 by being routed to a primary broker 6 who executes the trade 10 and provides confirmation 12 of that trade 4 to the trading system 10 which routes it to the client 2. The primary broker 6 is only aware that they are dealing with a single client, which is the omnibus system 10.

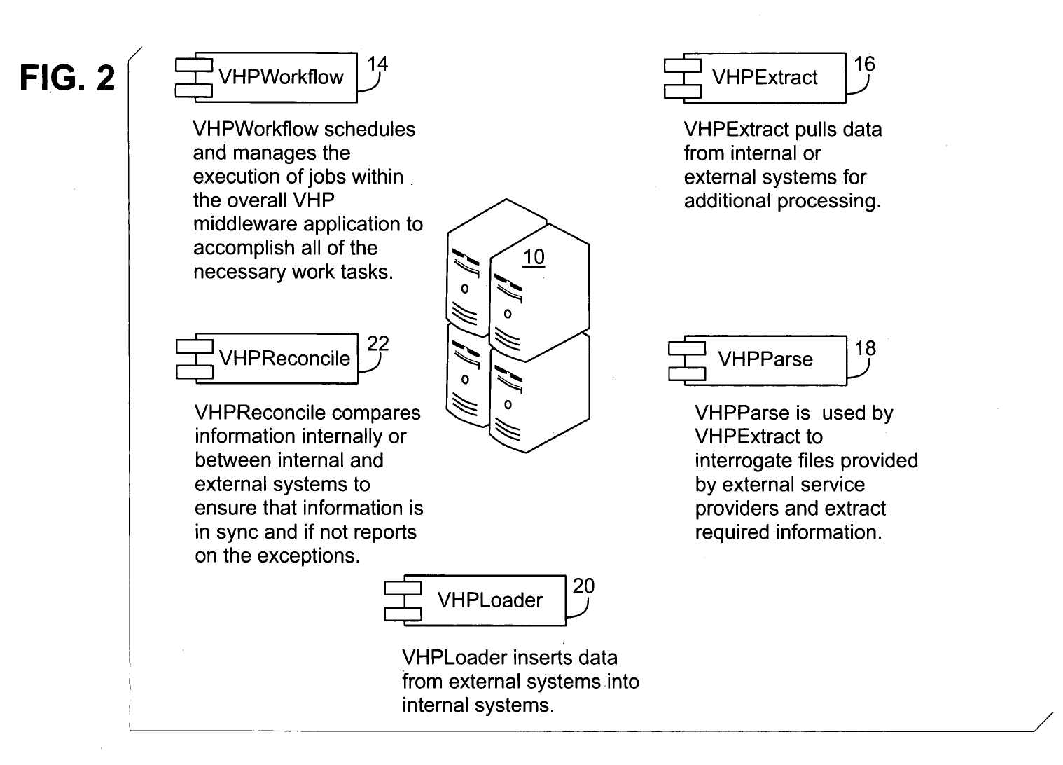

Referring to FIG. 2, within the omnibus trading system 10, there are a number of components to permit the information flow from the multiple clients 2 (1−∞) to the primary broker 6 while maintaining the trading appearance of a single client to the primary broker. Within the system, a workflow server 14 schedules and manages the execution of jobs within the overall omnibus trading system 10 to accomplish the necessary work tasks. An extract server 16 pulls data from internal and external systems for processing. In conjunction with the extract server 16, a parse server 18 is used to query files that are external to the system and are generally located and maintained by external service providers (not shown). This permits the interrogation of and extraction of data from external files to obtain the information necessary to permit the various tasks accomplished by the omnibus system 10. The information obtained by the extract server 16 is loaded into the internal operating system of the omnibus trading system 10 through a loader server 20. Once the information is loaded, and the workflow server 14 determines that it is time to, for example, reconcile information (a task that may being constantly done or may be done at particular times), a reconciliation server 22 compares the information that is internal to the system 10 as well as information that is both internal with information which is external to the system and may have been obtained by the extract server 16 to ensure that all of the information is consistent and reconciled. In the event that there is a discrepancy, as that is defined by the system 10, a report of the exception may be generated. This permits action to ensure that the trade 4 is cancelled, corrected or that some other remedial action is undertaken.

As can be more fully appreciated with reference to FIG. 3, the omnibus trading system 10 is web based to permit rapid interchange of trade and account data and access to external data bases. A client 2 engages the services of the system 10 by entering into contractual relationship with the system operator 24 and providing owner information and account information to the system operator to create a client set-up file 30 within the system 10. The client set-up file 30 will be unique to that client 2 and may generally be accessed by the client during the course of each trading day to obtain information relating to the client's account.

A part of the client 2 set-up file 30 creation involves obtaining client data for creation of a data repository 32 in a books and records sub-system 40 of the trading system 10. That data repository 32 is unique to each client 2 such that the client activity may be loaded into that repository. In one embodiment of the invention, a books and records portfolio accounting system such as that of GENEVA may be use to accomplish this function. However it can be appreciated that other accounting and record systems may be used to accomplish this purpose.

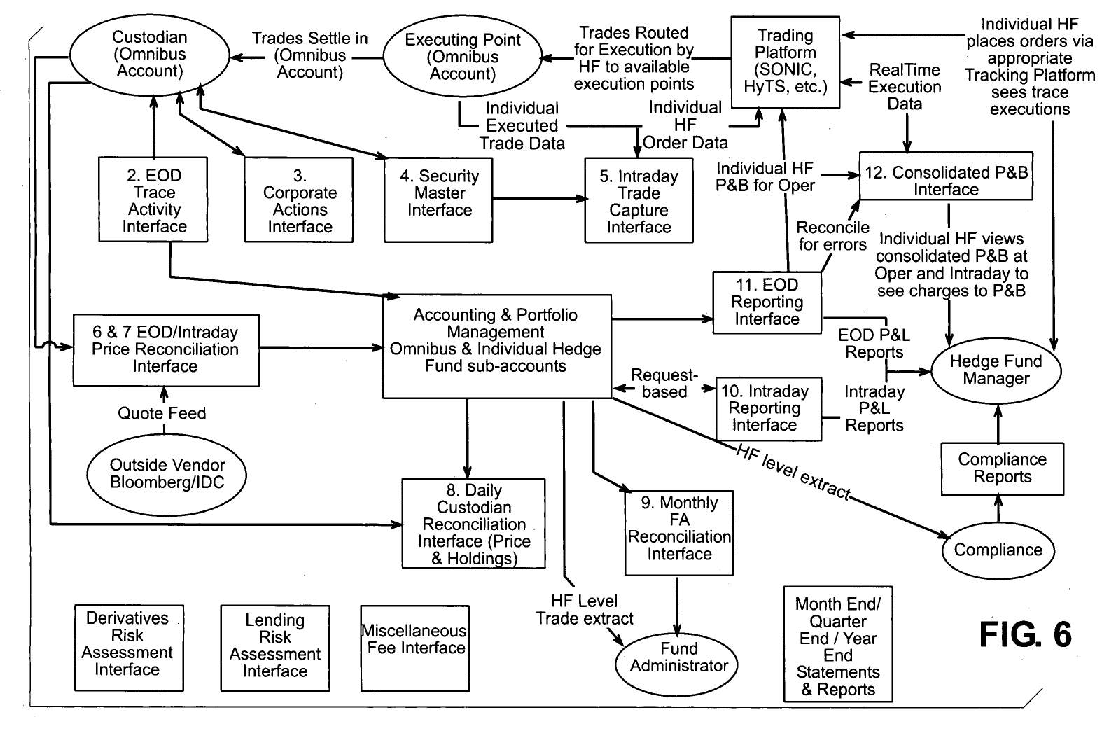

In one embodiment of the invention, which can best be seeing by referencing FIGS. 3, 5 and 6, a number of clients 2, which for this illustration may be hedge fund managers 2, place their respective trades 4 using the trading system 10 and provide all trade information to the system so that the individual fund manager 2 can be recognized by the system. The system 10 then routes the trades 4 to a prime broker 6 who affects the trades though an omnibus account on a non-disclosed basis. Once the trade has been executed, the system 10 commences its capture of information relative to that trade 2. It can be appreciated that the system 10 is capturing information from multiple sources relating to multiple trades 2 from multiple clients 2 simultaneously and therefore this example is merely illustrative.

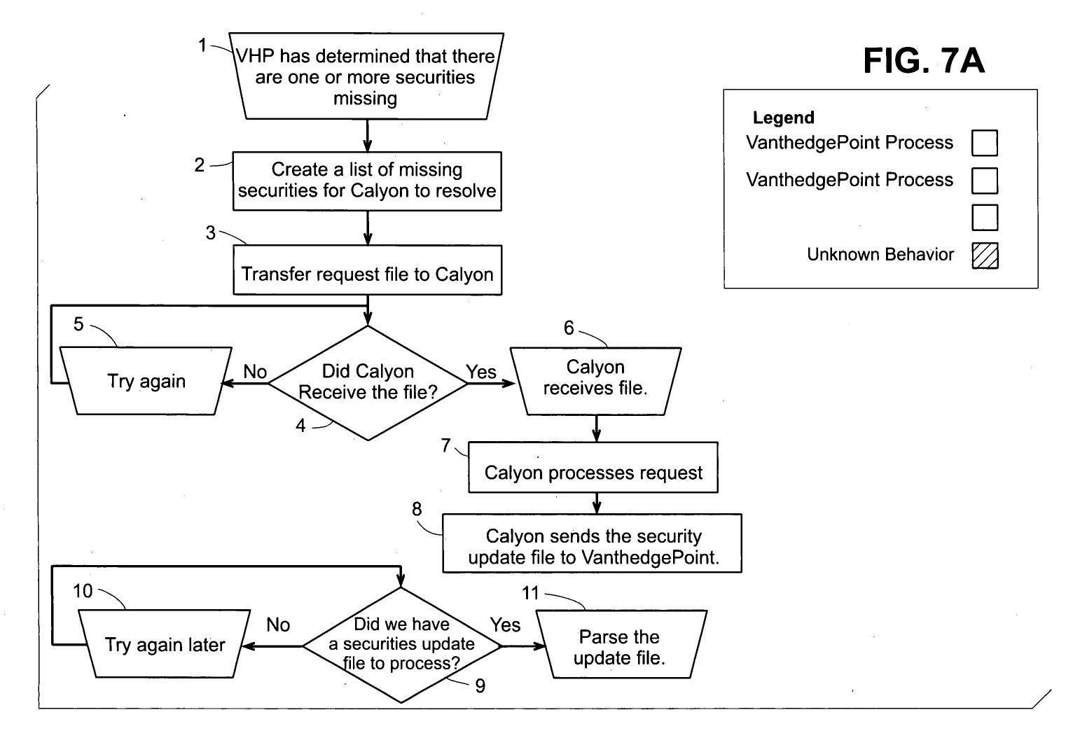

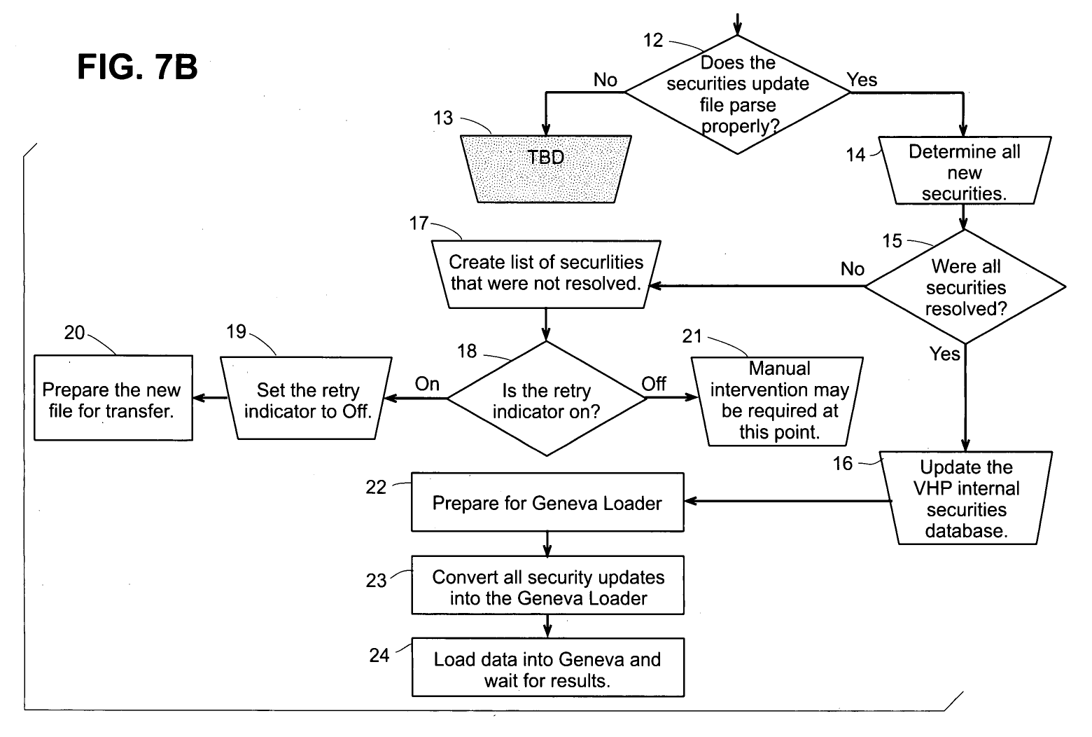

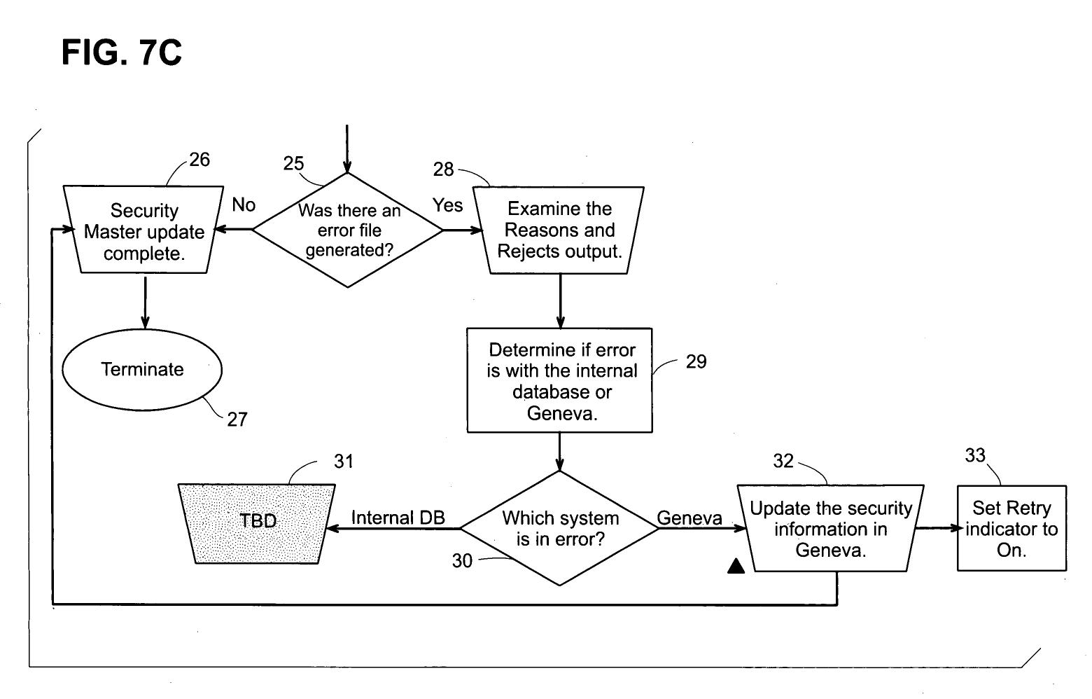

A trade capture file 50 is created and forwarded to the system operator 24. The system operator 24, using the system 10, verifies that the trade capture file 50 is valid. If it is not valid, then the system 10 queries the provider and has them fix the data file 50. Once the system 10 has verified the client 2 information and the trade capture file 50, it verifies the trades 4 against the data contained in the master securities repository 60. A fuller description of that verification is shown diagrammatically in FIG. 7 and will be detailed at a later point. However, as can be seen from FIG. 3, the information that was obtained during the initial client set-up was also employed to create an omnibus security master repository 60 for activity reconciliation purposes. The system 10, determines whether or not all securities in the trade file 50 exist in the omnibus security master repository 60. If there is a determination that a security does not exist in the security master repository 60, then the system 10 sends out queries to resolve the missing securities. Until there is a confirmation of the existence of the securities, no further processing of the trade 4 occurs. The system 10 continues to request resolution until it gets a positive response. No trade 4 is loaded without confirmation of the existence of the securities.

Once the system 10 obtains a positive response to the existence of the securities, the trade data is loaded into the books and records system 40 with designation of the unique client 2 identifier. At that point the system 10 undertakes a number of operations to reconcile the trade 4, attribute it to the client 2 (1−∞), confirm the client's ability to make the trade (buying power/margin requirements, etc.), prepare reports and otherwise provide to each of the clients 2 on a sub-account basis the information which the client needs and requires. The client 2 will obtain data as if it were a primary broker account holder, while not having to deal with a primary broker or incur the expense of being a small account with a primary broker.

As can be more fully appreciated by reference to FIG. 3, taken in conjunction with FIG. 5, one of the important functions of the system 10 is to ensure that each client 2 has the financial capacity to engage in the particular securities transaction and that each client has the financial capacity to engage in the aggregate series of securities transactions. Thus, the system 10 via the extract server 16 and its attendant programs, through its margin system 70, reviews each client's 2 account against the rules relating to the grant of credit to each client. These rules are generally referred to in the securities business as margin rules and are established by regulatory authorities to limit the amount of borrowed funds that a client may use to purchase securities, relative to the value of the securities and available funds (generally cash or cash equivalents) that the client 2 maintains in its account. The margin system 70 calculates the client's 2 buying power 72, which is extracted form the margin system 70 and the positions and balances information extracted from the books and records system 40. Once the buying power 72 has been determined, the information is disseminated to the trading platform 74 and the custody system 76 which ensure that only trades which do not cause the client 2 to violate the margin rules are permitted. As a further part of the margin system 70, additional rules relating to margin and other credit data as determined by the system operator 24 may be used to further limit any client's 2 ability to affect trades through the omnibus trading system 10. Each client 2 has available to them a daily margin report 78 which may be accessed by the client via the Web. That margin report 78 is also loaded into the portfolio accounting system 80 to permit the generation of reports such as mark-to-market, positions, and related reports that are needed for the client 2 to maintain their respective records and profit and loss data.

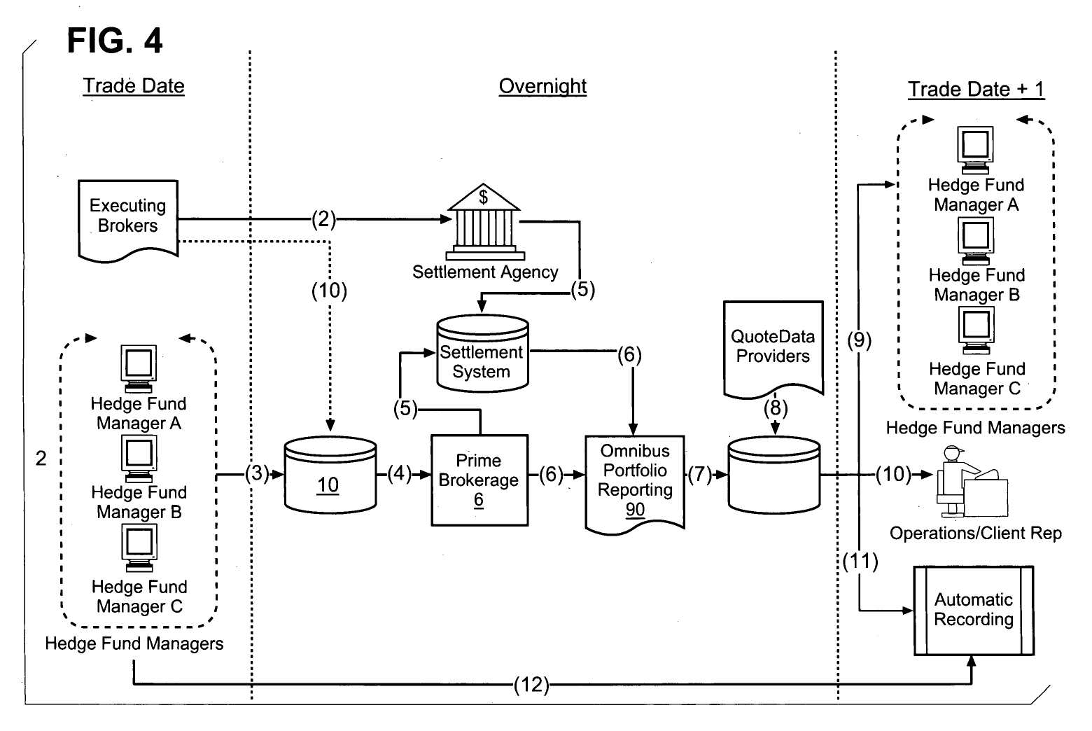

FIG. 4 illustrates another embodiment of the invention wherein the system 10 processes trades from a number of clients 2 on a non-disclosed basis through it trading software (not shown). That trading software can aggregate trades 4, place the trades and input the trade data into the books and records system 40 to keep the individual client accounts constantly updated. More specifically, the hedge fund managers 2 place their respective trades using the computer system 10. The fund managers' information and trades are submitted by the system 10 to a prime broker which maintains an omnibus account. That omnibus account is only sub-accounted by the computer system of the present invention, not by the prime broker. The prime broker submits trades through a settlement system. On the same trade date, each of the fund managers communicates their respective executed trade information to the system of the present invention, the carrying broker/dealer that maintains the omnibus account with prime broker communicates the executed trade information for all managers to the prime broker, but does so as a single client on a non-disclosed basis for the hedge fund managers. Therefore, the prime broker sees a disclosed single client.

As a further part of the invention, trades are processed through the prime broker trade processing system and submitted to the settlement system to set up DVP/RVP instruction to a settlement agent against each prime broker. The settlement agent does an automated overnight match of instructions and sends back data of matched and unmatched trades. The trade information processed through the prime broker's system and settlement system is submitted to the prime broker's omnibus portfolio reporting system which then submits it to the prime broker's omnibus portfolio management system. That, in turn, provides data to the sub-account system maintain by the present invention.

As yet another part of the invention, Data/Quote providers supply information to computer system of the present invention, though its sub-account system, to determine portfolio position values which it then delivers to each respective hedge fund manager through direct feed or through computer interface.

It is still another aspect of the invention that the system provides reports for client representative and operations teams to permit them to use the data and reports for promotional and marketing purposes as well as compliance and audit functions.

Another aspect of this invention permits each hedge fund manager to have the option of sending a feed of position and cash balance data to be reconciled with the computer system's Sub-Account System data using internal software. The reconciliation software produces reports of breaks between each hedge fund manager's portfolio data and the Prime Brokerage portfolio data without disclosing the manager's identity to the Prime Broker.

In yet another embodiment of the invention, the system permits trade execution, reporting, trade monitoring, account management, and related functions. As can be appreciated and as is more fully depicted in FIG. 2 and FIG. 5, an activity extraction system 80 extracts client activity information from the trading platform and simultaneously forwards it to the omnibus activity compilation system 90, the buying power system 100 and the books and records system 40. The books and records system 40, by using the client 2 information, in conjunction with the data generated by the buyer power system 100, generates a hypothecation analysis 102 which is employed by the margin system 70 to generate daily margin reports, both for the benefit of the client 2 and to permit reconciliation and prevent margin rule violations. It can be appreciated that since positions are reconciled by the system operator 24, the client has the benefit of receiving data as though it were dealing directly with a prime broker, and the prime broker has the benefit of only having to deal with a single account.

As is shown illustratively in FIG. 3, the trading system 10 is comprised of a number of major modules which operate together to provide the optimal omnibus trading system. It can be appreciated that one or more of the modules may be eliminated and the function provided externally or by non-operator provider without deviating from the scope of the invention. Referring to FIG. 3, in the Initial Client Set-up (Box A) 110, the prospective client undertakes to do one or more of the following:
Provide account information, including settlement instructions, wiring instructions and details of the assets being moved to the account
(equities, options, futures, etc.)
Provide asset movement instructions.
Confirm asset movement.
   Upon receipt of a confirmation that the assets have been received by the custodian in a sub-account within the master securities repository, the information and account data is entered into the books and records and an account turn-on flag is set to permit position transfer by way of trades 4.

In the books and records (Box B) system 40, the information that has been loaded is reconciled against each trade 4 to maintain a current portfolio that can be accessed by the client 2 during the trading day via the Web. In the Margin System (Box C) 120, the trading system 10 calculates each client's 2 buying power before the start of the trade day and load that calculation into the trading system 10. In order to perform that calculation, the Margin System 120 extracts the quantity of securities, the security identifier (eg CUSIP), the closing price of each security and the margin eligibility for security held by each client 2. Certain of the information can be extracted from the books and records system 40 while other information may be obtained from data vendors or can be generated by setting a rule within the Margin System 120, such as: “A security is eligible for margin only if its share price is greater than $5.00 at the close of the trading day.” The Margin System 120 generates a determination of buying power 122 which is the sum of the margin of all securities within an account calculated at a straight 50% of the value of each security having a share price above a certain set point. The buying power 122 is extracted from the Margin System 120 through the extract server 14 and is loaded into the trading platform, along with position and balance 124 before the start of the trading day. Concurrently with the determination of buying power 122, the Margin System 120 generates a margin report 126 which is extracted and delivered to the client 2 before the start of the trading day.

During the course of the trading day, each client 2 trades through the trading platform, but the prime broker only sees trades coming from the system operator 24 and only maintains a single account for that system operator. At the close of the trading day, the omnibus trading system 10 reconciles the day's trades. As can be seen illustratively in FIG. 3, the following activities may be undertaken via the trading system 10. At the end of the trading day a Trade Activity File(s) 130 sent to the system operator 24.

The Trade Activity File 130 will generally comprise:
Omnibus Trade Activity File 132
Client Sub-Account Trade Activity File 134.
   Upon receipt of the Trade Activity File 130, the omnibus trading system undertakes the following:
   Activity Extraction (Box G) 140 which may comprise the steps of:
1. Reverse the Omnibus Trade Activity File 132.
2. Load the Omnibus Activity File 132 into the books and records system 40.
3. Handle Omnibus Activity File 132 load errors.
4. Load the Sub-Accounts Activity File 134 into the books and records system 40.
5. Handle Sub-Accounts Activity File 134 load errors.
   Activity Reconciliation (Box H) 142, which may comprise the steps of:
1. Omnibus Activity Aggregated by Trade Type and then Security Code is extracted from books and records system 40 (only activity that is tagged with an identifier).
2. Sub-Accounts Activity aggregated by Trade Type and then Security Code is extracted from books and records system 40 (only activity that is tagged with an identifier.)
3. Omnibus and Sub-Accounts Activities are reconciled.
4. Exceptions are reported.
5. Exceptions are corrected.
   Omnibus Activity Load (Box 1) 144, which may comprise the steps of:
1. Extract the Omnibus Trade Activity File 132 from books and records system 24 in a file format that can be used by a Custodian 146 of the securities.
2. Omnibus Trade Activity File 132 is made available to the Custodian 146.
3. Custodian 146 performs a batch run 148 to verify positions in Omnibus Trade Activity File 132.
4. The Custodian 146 makes an Omnibus Positions File 150 and an Omnibus Transactions File 152 for the system operator 24 to retrieve.
   Positions and Balances Reconciliation (Box J) 154, which may comprise the steps of:
1. Process the Journal entries in the Omnibus Activity file 132 into the books and records system 40.
2. Extract from the books and records system 40 the Omnibus Positions and Balances by Trade, Type, Security Identifier and Quantity.
3. Parse the Custodian Omnibus Positions File 150 for the same information.
4. Compare against the books and records system 40 information for reconciliation.
5. If there are any exceptions, pull out of the Omnibus Transaction file 152 from the Custodian 146 and parse all activity associated with that security.
6. Pull out of the books and records system 24 the same information
7. Compare the extractions to find source of the discrepancies.
8. Correct the discrepancies.
9. Re-run the reconciliation.
   Omnibus versus Sub-Accounts Positions and Balances Reconciliation (Box L) 160, which may comprise the steps of:
1. Extract via the extract server Omnibus Positions and Balances information out of books and records system 24.
2. Extract via the extract server aggregated Sub-Accounts Positions and Balances out of books and records system 24.
3. Reconcile the Omnibus Positions and Balances versus the Sub-Accounts Positions and Balances.
4. If an exception is generated, extract the activity associated with that security for that day from both the Omnibus and the Sub-Accounts from Geneva.
5. Compare the activities to find the discrepancies.
6. Correct the discrepancies.
7. Re-run the reconciliation.
   Hypothecation (Box R) 164, which may comprise the steps of:
1. For each portfolio with a free credit balance extract out of the books and records system 24 an aggregated list of securities across all portfolios.
2. Transfer the list of the Custodian.
3. Handle any transfer errors.
4. Receive a report from the Custodian the next day that lists securities that have been locked up in customer segregation.
5. Compare the Custodian report with our instructions.
6. Handle any exceptions.
   Cash Reconciliation (Box P) 166, which may comprise the steps of:

### I. Internal

1. Extract the ledger report for the combined Omnibus+Revenue portfolios.
2. Extract the ledger report for the aggregated portfolios.
3. Reconcile the two reports.
4. If exception is a trade, re-run position/activity reconciliations.
5. If not trade-related issue, investigate and correct.
6. Correct the exceptions.
7. Re-run reconciliation.

### II. External.

1. After processing the Journal entries out of the Custodian activity file, extract out of books and records system 24 the cash balances.
2. Parse the Custodian balances file for the cash balances.
3. Reconcile the Cash Balances
4. If there is an exception, extract all of the cash journal entries out of the books and records system 24.
5. Parse the Custodian activities file for journal entries.
6. Compare the journal entries to find the discrepancies.
7. Correct the discrepancies.
8. Re-run the reconciliation.
   Reports (Box Q) 170, which may comprise the generation of one or more of the following:

### I. Client 2 Reports

1. Appraisal
2. Daily Activity (Prior Day)
3. Profit & Loss
4. Pending Activity (Prior Day)
5. Cash Balances/Cash Management/Report
6. Corporate Actions Report
7. Margin Report

### II. System Operator

1. Client Performance
2. Daily Share Volume
3. Client Trade Volume (Daily)
4. Client Market Value Report (Daily)
5. Market Value Movement Report
6. Client Long/Short Breakdown

Although particular forms of systems appear in the figures and the description, those skilled in the art will recognize that any number of variations of the trading system could be used to implement the methods of the various embodiments of the present invention. In addition, many of the reconciliation tasks could be done externally to the system operator and certain other tasks and reports could be omitted if not required by the client. Although the description of the fund management identifies hedge funds as a primary beneficiary of the invention, it is not limited to hedge funds. It is applicable to commodities trading, currency trading, foreign securities (both equities and debt), options trading and other trading vehicles and methodologies. Those skilled in the art will recognize that there exist a substantial number of variations of trading methodologies and securities that could be used in conjunction with one or more aspects of the invention and that the invention could be implemented with multiple trading strategies and techniques beyond hedge funds. While the above is a complete description of specific embodiments of the invention, numerous additional embodiments are possible. Moreover, various aspects of the invention may be modified, combined, taken in varying order, added to or taken out without departing from the spirit and breadth of the invention. Similar pathways and equivalent means and steps may be employed within the scope of the inventive concept. Therefore, the above descriptions should not be taken as in any way limiting the scope of invention, which is defined by the appended claims.

What is claimed is:

1. A trading system for a plurality of traders each having an individual trading account comprising:
a) trading platform means for receiving from each trader one or more trades in their respective trading accounts;
b) transmission means for transmitting the trades from the individual trading accounts to a single, omnibus trade account maintained at an entity capable of either executing the trades or having the trades executed;
c) means for transmitting all of the executed trades from the omnibus trade account to the trading platform;
d) means for reconciling the executed trades with the trades transmitted by each trader;
e) means for extracting the individual trades from the executed trades transmitted to the trading platform and distributing them to the respective individual trading accounts;
f) means for confirming the individual trades to each trader; and,
g) means for settling the trades.

2. The trading system of claim 1, wherein the transmission means is the Internet.

3. The trading system of claim 1, wherein the trading platform further comprises trade limiting means to prevent any individual trader from having a trade executed in violation of any rule of the trading system.

4. The trading system of claim 3, wherein the trade limiting means is a function of the value of the individual trading account.

5. The trading system of claim 3 wherein the trade limiting means calculates daily the value of the individual trading account and resets the limit as a function of the value of the individual trading account.

6. A method of receiving and executing trades for a plurality of traders each having an individual trading account comprising:
a) receiving from each trader one or more trades in their respective trading accounts;
b) transmitting the trades from the individual trading accounts to a single, omnibus trade account maintained at an entity capable of either executing the trades or having the trades executed;
c) transmitting all of the executed trades from the omnibus trade account to the trading platform;
d) means for reconciling the executed trades with the trades transmitted by each trader;
e) extracting the individual trades from the executed trades transmitted to the trading platform and distributing them to the respective individual trading accounts; and,
f) confirming the individual trades to each trader.

7. The method of claim 6, comprising the further step of settling the trades.

8. The method of claim 6, wherein the trades are transmitted over the Internet.

9. The method of claim 6, comprising the further steps of:
a) calculating the value of each trading account; and,
b) setting a limit to the value of trades that may be executed within each account as a function of the calculated value of that account.

10. The method of claim 6, comprising the further step of providing to one or more of the traders reports of their respective accounts.

11. The method of claim 10 wherein the reports are provided via the Internet.

12. The method of claim 10 wherein the reports are provided via a secure Web site.

13. The method of claim 6 comprising the further step of providing funds to one or more of the traders to permit them to leverage their individual accounts
